(19) United States
(12) Patent Application Publication
(10) Pub. No.: US 2024/0161190 A1
(43) Pub. Date: May 16, 2024

(54) ENERGY TRADING METHOD AND SYSTEM FOR SUPPORTING ENVIRONMENTAL, SOCIAL, AND GOVERNANCE MANAGEMENT

(71) Applicant: ELECTRONICS AND TELECOMMUNICATIONS RESEARCH INSTITUTE, Daejeon (KR)

(72) Inventors: Yoon-Sik YOO, Daejeon (KR); IL Woo LEE, Daejeon (KR)

(21) Appl. No.: 18/378,307

(22) Filed: Oct. 10, 2023

(30) Foreign Application Priority Data
Nov. 4, 2022 (KR) 10-2022-0146358
Aug. 11, 2023 (KR) 10-2023-0105651

(51) Int. Cl. G06Q 40/04; G06Q 50/06

(52) U.S. Cl. CPC G06Q 40/04; G06Q 50/06

(57) ABSTRACT

An energy trading method and system for supporting environmental, social and governance (ESG) management are provided. More specifically, the method and the system enhance environmental, social and governance (ESG) management of a factory by evaluating utility through energy trading between a main grid and a factory having a distributed resource.

### CROSS-REFERENCE TO RELATED APPLICATIONS

This application claims the benefit of Korean Patent Application No. 10-2022-0146358, filed on Nov. 4, 2022, and Korean Patent Application No. 10-2023-0105651, filed on Aug. 11, 2023, in the Korean Intellectual Property Office, the entire disclosures of which are incorporated herein by reference for all purposes.

### BACKGROUND

### 1. Field of the Invention

One or more embodiments relate to an energy trading method and system, and more specifically, to a method and a system to enhance environmental, social and governance (ESG) management of a factory by evaluating utility through energy trading between a main grid and a factory having a distributed resource.

### 2. Description of Related Art

Since an existing main grid provides energy at a fixed energy price for energy requested based on a single distributed resource through an electric power retailer (e.g., Korea Electric Power Corporation), effective use of energy consumption is limited.

Recently, an environmental, social and governance (ESG) management model, which represents environment, social responsibility, and governance, has become an issue worldwide. Therefore, based on the guideline of the ESG management model, an energy trading system that can identify a domestic progress process to select ESG factors and apply the selected ESG factors to a factory energy management system (FEMS) needs to be established.

### SUMMARY

Embodiments are to provide an energy trading method and system that enhance environmental, social and governance (ESG) management of a factory by evaluating utility through energy trading between a main grid and a factory having a distributed resource.

However, technical goals are not limited to the foregoing goals, and there may be other technical goals.

According to an aspect, there is provided an energy trading method performed by an energy market of an energy trading system, the energy trading method including receiving ESG demand information from a target energy consumer of which an energy demand quantity is greater than an energy generation quantity among energy consumers of the energy trading system, receiving power generation information from an energy provider of the energy trading system, identifying a power generation quantity of the energy provider required to meet a demand of the target energy consumer using the received ESG demand information and the received power generation information, determining a power generation price that the target energy consumer needs to pay for purchasing energy from the energy provider according to the identified power generation quantity of the energy provider, and calculating an energy distribution quantity for each of target energy consumers to enhance ESG of all the target energy consumers based on the determined power generation price.

The ESG demand information may include at least one of an energy purchase quantity, a greenhouse gas emission quantity, or a new and renewable energy generation rate of the target energy consumer.

The power generation information may include at least one of an energy quantity currently stored or an energy production cost required to produce additional energy of the energy provider.

The calculating of the energy distribution quantity may include determining an energy distribution quantity per unit time for each of the target energy consumers so that a total utility of all the target energy consumers is maximized.

The total utility of all the target energy consumers may be determined based on a greenhouse gas emission quantity and a new and renewable energy generation rate included in the ESG demand information.

According to another aspect, there is provided an energy trading method performed by an energy market of an energy trading system, the energy trading method including receiving power generation information from an energy provider of the energy trading system, receiving renewable energy certificate (REC) information corresponding to surplus energy from a target energy consumer of which an energy demand quantity is less than an energy generation quantity among energy consumers of the energy trading system, identifying a power generation quantity that is reducible by the energy provider using the received REC information and the received power generation information, determining an REC price for the target energy consumer to sell surplus energy according to the identified power generation quantity of the energy provider, and transmitting the determined REC price to the energy provider, wherein the energy provider may purchase surplus energy from the target energy consumer at the determined REC price.

The energy trading method may further include receiving greenhouse gas credit information from the target energy consumer, wherein the energy provider may adjust a surplus energy quantity purchased from the target energy consumer based on the greenhouse gas credit information transmitted from the energy market.

According to another aspect, there is provided an energy trading system including an energy provider, an energy market, and an energy consumer, wherein the energy market may receive ESG demand information from a target energy consumer of which an energy demand quantity is greater than an energy generation quantity among energy consumers of the energy trading system, may receive power generation information from an energy provider of the energy trading system, may identify a power generation quantity of the energy provider required to meet a demand of the target energy consumer using the received ESG demand information and the received power generation information, may determine a power generation price that the target energy consumer needs to pay for purchasing energy from the energy provider according to the identified power generation quantity of the energy provider, and may calculate an energy distribution quantity for each of target energy consumers to enhance ESG of all the target energy consumers based on the determined power generation price.

The ESG demand information may include at least one of an energy purchase quantity, a greenhouse gas emission quantity, or a new and renewable energy generation rate of the target energy consumer.

The power generation information may include at least one of an energy quantity currently stored or an energy production cost required to produce additional energy of the energy provider.

The energy market may include determining an energy distribution quantity per unit time for each of the target energy consumers so that a total utility of all the target energy consumers is maximized.

The total utility of all the target energy consumers may be determined based on a greenhouse gas emission quantity and a new and renewable energy generation rate included in the ESG demand information.

Additional aspects of embodiments will be set forth in part in the description which follows and, in part, will be apparent from the description, or may be learned by practice of the disclosure.

According to embodiments, ESG management of a factory may be enhanced by evaluating utility through energy trading between a main grid and a factory having a distributed resource.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating a configuration of an energy trading system according to an embodiment;

FIG. 2 is a diagram illustrating an example of an energy trading method according to an embodiment; and

FIG. 3 is a diagram illustrating another example of an energy trading method according to an embodiment.

### DETAILED DESCRIPTION

The following detailed structural or functional description is provided as an embodiment only and various alterations and modifications may be made to embodiments. Here, embodiments are not construed as limited to the disclosure and should be understood to include all changes, equivalents, and replacements within the idea and the technical scope of the disclosure.

Although terms, such as first, second, and the like are used to describe various components, the components are not limited to the terms. These terms should be used only to distinguish one component from another component. For example, a first component may be referred to as a second component, and similarly the second component may also be referred to as the first component.

It should be noted that if it is described that one component is “connected”, “coupled”, or “joined” to another component, a third component may be “connected”, “coupled”, and “joined” between the first and second components, although the first component may be directly connected, coupled, or joined to the second component.

The singular forms “a,” “an,” and “the” are intended to include the plural forms as well, unless the context clearly indicates otherwise. As used herein, “A or B”, “at least one of A and B”, “at least one of A or B”, “A, B or C”, “at least one of A, B and C”, and “at least one of A, B, or C,” each of which may include any one of the items listed together in the corresponding one of the phrases, or all possible combinations thereof. It will be further understood that the terms “comprises/including” and/or “includes/including” when used herein, specify the presence of stated features, integers, operations, operations, elements, and/or components, but do not preclude the presence or addition of one or more other features, integers, operations, operations, elements, components and/or groups thereof.

Unless otherwise defined, all terms used herein including technical or scientific terms have the same meaning as commonly understood by one of ordinary skill in the art to which embodiments belong. Terms, such as those defined in commonly used dictionaries, should be construed to have meanings matching with contextual meanings in the relevant art and the present disclosure, and are not to be construed as an ideal or excessively formal meaning unless otherwise defined herein.

Hereinafter, embodiments will be described in detail with reference to the accompanying drawings. When describing the embodiments with reference to the accompanying drawings, regardless of drawing numerals, like reference numerals refer to like elements and a repeated description related thereto will be omitted.

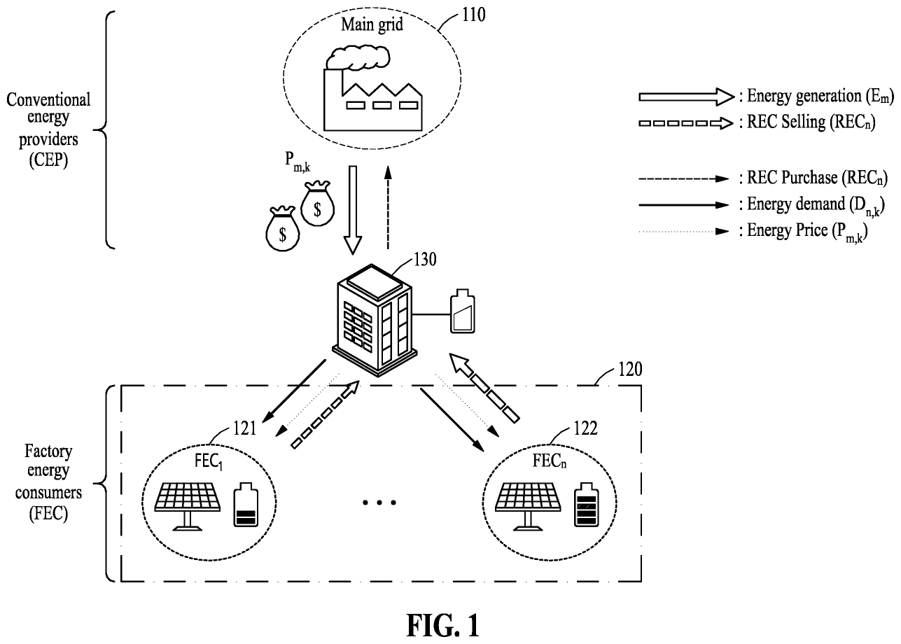

FIG. 1 is a diagram illustrating a configuration of an energy trading system according to an embodiment of the present disclosure.

Referring to FIG. 1, an energy trading system of the present disclosure may include a conventional energy provider (CEP) 110, factory energy consumers (FECs) 120, and an energy market 130. First, the CEP 110 may provide the energy market 130 with power generation information including an energy quantity produced through a central power plant m k and a production cost required to produce additional energy.

Here, the central power plant may be a large-scale power generation facility that produces a large amount of electricity using traditional power generation methods such as coal, natural gas, and nuclear power and is directly connected to a main grid. m may be determined according to the number of CEPs 110 and k may be determined according to the order of unit time.

The FECs 120 may provide the energy market 130 with demand information including an energy purchase quantity required to operate a factory and may purchase necessary energy from the CEP 110 through a relay of the energy market 130.

In addition, the FECs 120 may have a new and renewable energy power plant, such as photovoltaics (PV), and an energy storage system (ESS). Therefore, the FECs 120 may generate a demand resource, that is, surplus energy, through the new and renewable energy power plant and the ESS that the FECs 120 have. The FECs 120 may provide the energy market 130 with renewable energy certificate (REC) information including information on such surplus energy quantity and may resell the surplus energy to the CEP 110 through the relay of the energy market 130.

The energy market 130 may manage optimal energy distribution based on the power generation information provided from the CEP 110 and the demand information or the REC information provided from the FECs 120.

More specifically, the energy market 130 may analyze the demand information or the REC information received from the FECs 120 to evaluate whether the corresponding FEC has a large energy consumption quantity or a large energy generation quantity.

For example, the energy market 130 may receive demand information including an energy quantity required to operate a factory, that is, an energy purchase quantity, from an FEC 121 of which the energy demand quantity is greater than an energy generation quantity among the FECs 120 and may evaluate the demand information.

As a result of the evaluation, when the energy of the FEC 121 is determined to be in a deficient state, the energy market 130 may profile the received demand information as history information. The history information may be information in which energy consumption information and sales pattern information of the FEC 121 are organized by hour, day, month, and year.

The energy market 130, based on such history information, may generate energy trade information about when the corresponding FEC 121 needs energy and purchases energy from the CEP 110, and when the FEC 121 has surplus energy and sells energy to the CEP 110. The process of generating such energy trade information is profiling.

The energy market 130 may calculate an energy distribution quantity according to an energy purchase quantity per each FEC 121 through such profiling based on the history information.

In another example, the energy market 130 may receive REC information including information on a demand resource, that is, a surplus energy quantity, from an FEC 122 of which the energy demand quantity is less than an energy generation quantity among the FECs 120 and may evaluate the REC information.

As a result of the evaluation, when the energy of the FEC 122 is determined to be in a surplus state, the energy market 130 may list up available distributed energy resources and the optimal trading energy distribution quantity of the FEC 122 and may provide a function for each FEC 122 to resell the surplus energy.

The energy market 130 may provide an incentive according to the energy supply contribution to the CEP 110 that sells energy to the FEC 121 and may provide a benefit for the energy trading to the FEC 122 that sells the surplus energy to the CEP 110.

Moreover, the energy market 130 may maximize the sum of utilities of all FECs 120 under the concept of benefit to improve the utility of energy trading based on unit time. Therefore, the energy market 130 may derive an optimal benefit by improving the utility according to demand resources and loads to all FECs 120 as shown in Equation 1 below.

$$U ( x , ξ , λ ) = {\sum }_{i ∈ N , k ∈ K} U ( {x}_{i , k} , {ξ}_{i , k} , {λ}_{i , k} ) \qquad [ Equation 1 ]$$

Here, U(x_{i,k}, ξ_{i,k}, λ_{i,k}) denotes utility of an individual FEC FEC_{i,k} and U(x, ξ, λ) denotes total utility. Here, x_{i,k} denotes an energy quantity consumed in k unit time of an i-th FEC, ξ_{i,k} denotes a maximum charge quantity of the ESS in k unit time of the i-th FEC, and Δ_{i,k} denotes an energy quantity that the i-th FEC sells surplus energy to the CEP 110 through the energy market 130 in k unit time of the i-th FEC.

From the assumption, the energy market 130 may not allocate more energy than the energy the FECs 120 demand and the sum of all allocated energy may not exceed all the currently stored energy of the CEP 110.

For this, U(x_{i,k}, ξ_{i,k}, λ_{i,k}) may be defined as utility of the individual FEC FEC_{i,k} from the perspective of the energy market 130. When U(x_{i,k}, ξ_{i,k}, λ_{i,k}) is defined as the following assumptions and meaning, U(x_{i,k}, ξ_{i,k}, λ_{i,k}) may be a non-negative real-valued function, a strictly increasing function of ρᵢx_{i,k}, and a concave function of Δ_{i,k}. In addition, a quadratic utility function may be generally used to measure user utility using characteristics of a demand resource. Therefore, Equation 2 below may be considered as a utility function of the individual FEC FEC_{i,k} from the perspective of the energy market 130.

$$U ( {x}_{i , k} , {ξ}_{i , k} , {λ}_{i , k} ) = \{ \begin{matrix}{ρ}_{i} {x}_{i , k} - \frac{{ρ}_{i}}{2 {ξ}_{i , k}} {x}_{i , k}^{2} - {λ}_{i , k} , & if 0 \leq {x}_{i , k} \leq {ξ}_{i , k} \\ \frac{{ρ}_{i} {ξ}_{i , k}}{2 {ξ}_{i , k}} - {λ}_{i , k} , & if x \geq {ξ}_{i , k}\end{matrix} \qquad [ Equation 2 ]$$

Here, ρᵢ denotes a preference of the i-th FEC and K={1, 2, . . . , N} may be defined as a unit time index set of all FECs 120. In addition, an FEC prefers those with more utility value, where the utility value may mean satisfaction. Thus, the preference may mean more satisfaction. Here, the FEC may be more satisfied when consuming more energy rather than less energy.

Therefore, an energy distribution policy for energy trading of new and renewable energy based on unit time may be determined as in Equation 3 below.

$${maximize}_{H} {\sum }_{i}^{N} \text{} {\sum }_{k}^{K} \text{} ( ω U ( {x}_{i , k} , {ξ}_{i , k} , {λ}_{i , k} ) - {C}_{RES} ( {g}_{i , k} ) - {C}_{ESS} ( {e}_{i , k} ) - {C}_{GHG} ( {x}_{i , k} ) + {C}_{RR} ( {e}_{i , k} ) ) + {\sum }_{k}^{K} ( F ( {R}_{k} ) - {G}_{G} ( {G}_{k} ) ) \qquad [ Equation 3 ]$$

$$subject to {\sum }_{i}^{N} ( {x}_{i , k} + {e}_{i , k} - {g}_{i , k} ) \leq {G}_{k} , ∀ k ∈ K {\sum }_{i}^{N} ( {g}_{i , k} ) = {R}_{k} , ∀ k ∈ K$$

Here H={x_{i,k}, ξ_{i,k}, λ_{i,k}, g_{i,k}, e_{i,k}|i∈K, k∈K} and ω denotes a weight factor. In addition, C_{RES}(g_{i,k}) denotes a PV operation cost, C_{ESS}(e_{i,k}) denotes an energy charging and discharging cost of the ESS, C_{GHG}(x_{i,k}) denotes a greenhouse gas emission quantity, C_{RR}(e_{i,k}) denotes a new and renewable energy generation rate, F(Rₖ) denotes a gain from trading new and renewable energy, and G_{G}(Gₖ) denotes an energy production cost of the CEP 110.

In addition, e_{i,k} denotes an energy quantity charged from the CEP 110 through the trading with the energy market 130 in k unit time of the i-th FEC, g_{i,k} denotes an energy quantity of new and renewable energy provided to the CEP 110 through the trading with the energy market 130 in k unit time of the i-th FEC, Rₖ denotes a quantity of new and renewable energy produced by an R unit in k unit time, and Gₖ denotes an energy quantity generated by the CEP 110 in k unit time.

In addition, the constraints are that the demand of the FECs 120, the charging and discharging quantity of the ESS, and the quantity of PV used need to be less than the energy production quantity of the CEP 110, and the PV production quantity needs to be equal to the total amount of new and renewable energy.

That is, since an objective function is a strictly concave function and the constraints are linear, Equation 4 below may be given as Lagrangian and duality conditions.

$$ℒ ( H , v , o ) = {\sum }_{i}^{N} \text{} {\sum }_{k}^{K} \text{} ( ω U ( {x}_{i , k} , {ξ}_{i , k} , {λ}_{i , k} ) - {C}_{RES} ( {g}_{i , k} ) - {C}_{ESS} ( {e}_{i , k} ) - {C}_{GHG} ( {x}_{i , k} ) + {C}_{RR} ( {e}_{i , k} ) ) + {\sum }_{k}^{K} ( F ( {R}_{k} ) - {G}_{G} ( {G}_{k} ) ) - {\sum }_{k}^{K} {v}_{k} ( {\sum }_{i}^{N} ( {x}_{i , k} - {g}_{i , k} + {e}_{i , k} ) - {G}_{k} ) + {\sum }_{k}^{K} {o}_{k} ( {\sum }_{i}^{N} {g}_{i , k} - {R}_{k} ) \qquad [ Equation 4 ]$$

Therefore, an optimal energy trading policy of x*={x*^{i,k}|i∈K, k∈K} as in Equation 5 below may be determined, and the energy market 130 may manage optimal energy distribution according to the determined optimal energy trading policy.

g(v,o)=max_{H} [symbol] (H,v,o)

D(v,o)=min_{v≥0,o}g(v,o) [Equation 5]

Here, g(v,o) may be a formula to obtain the maximum value by converting the objective function into a Lagrangian function and D(v,o) may be a formula to obtain the minimum value using the duality of the Lagrangian function.

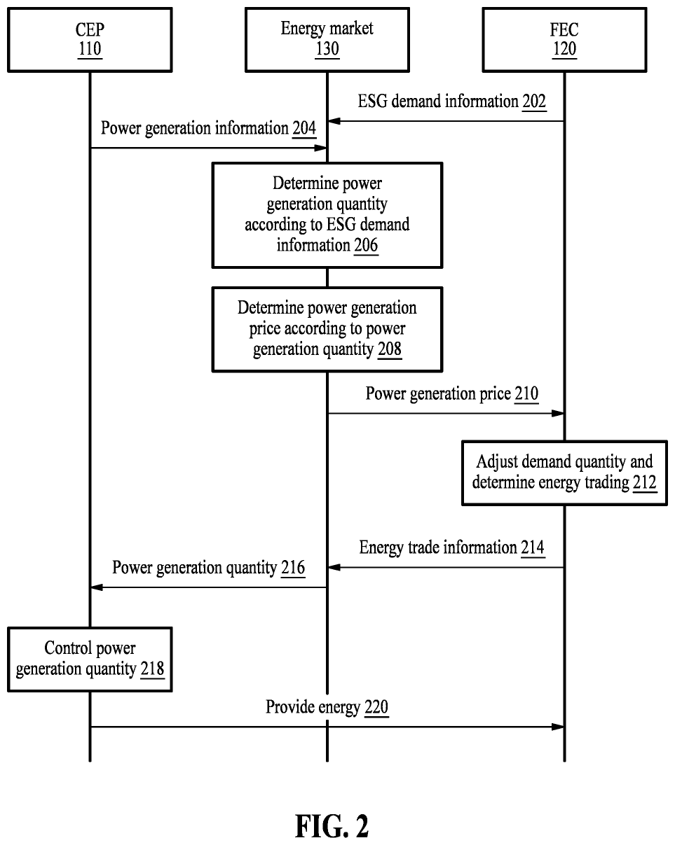

FIG. 2 is a diagram illustrating an energy trading method according to a first embodiment of the present disclosure.

In operation 202, the energy market 130 may receive environmental, social and governance (ESG) demand information including at least one of an energy purchase quantity required to operate a factory, a greenhouse gas emission quantity, or a new and renewable energy generation rate from the FEC 121 of which the energy demand quantity is greater than an energy generation quantity among the FECs 120. Since the FEC 121 does not have surplus energy because the new and renewable energy generation quantity is small according to the ESG demand information, the ESG score may be evaluated to be low. Here, the evaluation of the ESG score of the FEC 121 may vary depending on the greenhouse gas emission quantity. When the greenhouse gas emission quantity is large, the ESG score may be evaluated lower than when the greenhouse gas emission quantity is small.

In operation 204, the energy market 130 may receive power generation information including an energy quantity produced through the central power plant (P_{m,k}) and a production cost required to produce additional energy from the CEP 110.

In operation 206, the energy market 130 may proceed with a bid to determine the power generation quantity of the CEP 110 required to meet the demand of the FECs 120, based on the power generation information provided from the CEP 110 and the ESC score according to the ESG demand information provided from the FECs 120.

In operation 208, the energy market 130 may determine a power generation price as a system marginal price (SMP), that is, a market price, wherein the power generation price needs to be paid by the FECs 120 to purchase energy from the CEP 110 according to the power generation quantity of the CEP 110 determined in operation 206 and the production cost included in the power generation information. For example, the market price may be determined on an hourly basis. In addition, a price model of a main grid is assumed to be given by determining the price at a power exchange according to the law of supply and demand. In the case of new and renewable energy, when the CEP 110 suggests a power generation quantity and a price, the price and demand are assumed to be determined by adjusting the demand quantity according to the price by the FECs 120.

In operation 210, the energy market 130 may transmit the power generation price or the market price determined in operation 208 to the FECs 120.

In operation 212, the FECs 120 may determine energy trading by adjusting the demand quantity according to the received power generation price or the received market price and may transmit the determined energy trade information to the energy market 130 in operation 214.

In operation 216, the energy market 130 may transmit the power generation quantity corresponding to the energy quantity to be produced additionally to the CEP 110 based on the energy trade information received from the FECs 120.

In operation 218, the CEP 110 may generate additional energy by controlling the power generation quantity according to the power generation quantity received from the energy market 130 and in operation 220, may provide energy to the FECs 120 by providing energy at the time of the trading.

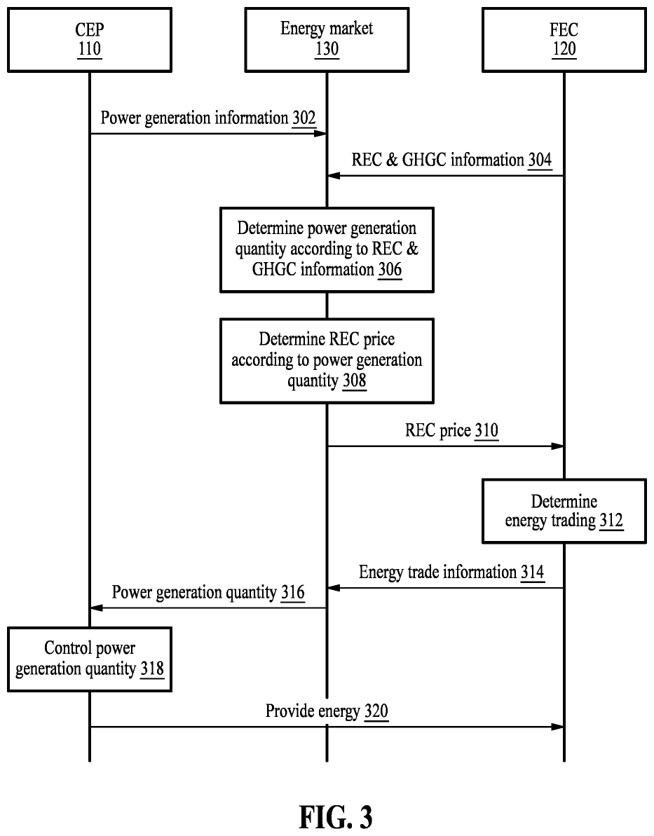

FIG. 3 is a diagram illustrating an energy trading method according to a second embodiment of the present disclosure.

In operation 302, the energy market 130 may receive power generation information including an energy quantity produced through the central power plant (P_{m,k}) and a production cost required to produce additional energy from the CEP 110.

In operation 304, the energy market 130 may receive REC information including information on a demand resource, that is, a surplus energy quantity, from the FEC 122 of which the energy demand quantity is less than an energy generation quantity among the FECs 120. Since the FEC 122 has surplus energy because the new and renewable energy generation quantity is large according to the REC information, the ESG score may be evaluated to be high. Here, the evaluation of the ESG score of the FEC 122 may vary depending on the greenhouse gas emission quantity. When the greenhouse gas emission quantity is small, the ESG score may be evaluated to be higher than when the greenhouse gas emission quantity is large. In operation 306, the energy market 130 may proceed with a bid to determine the power generation quantity that the CEP 110 may reduce, based on the received REC information and the ESC score according to greenhouse gas credit (GHGC) information.

In operation 308, the energy market 130 may determine an REC price that the FECs 120 may obtain by selling the surplus energy to the CEP 110 according to the power generation quantity of the CEP 110 determined in operation 306 and the production cost included in the power generation information.

In operation 310, the energy market 130 may transmit the REC price determined in operation 308 to the FECs 120.

In operation 312, the FECs 120 may determine energy trading according to the received REC price and may transmit the determined energy trade information to the energy market 130 in operation 314.

In operation 316, the energy market 130 may transmit the power generation quantity corresponding to the energy quantity to be reduced to the CEP 110 based on the energy trade information received from the FECs 120.

In operation 318, the CEP 110 may reduce energy produced by controlling the power generation quantity according to the power generation quantity received from the energy market 130. In operation 320, the CEP 110 may receive surplus energy supplied from the FECs 120 at the time of the trading.

That is, each of the FECs 120 may demand and consume energy from the CEP 110 in the non-peak time period of the demand resource and when surplus energy is generated, may sell the surplus energy to the CEP 110 at the peak time period to optimize a benefit.

In addition, the energy market 130 may further receive the GHGC information from the FEC 122 of which the energy demand quantity is smaller than the energy generation quantity and may sell the GHGC information to the CEP 110. A GHGC is to sell credit as much as energy savings or a quantity of reduced carbon dioxide, which may mean a reduction quantity trade. That is, a company (e.g., a power plant) or an organization that purchases the GHGC may offset a carbon dioxide emission quantity by accumulating a quantity of carbon dioxide reduced as much as the purchased GHGC.

The components described in the embodiments may be implemented by hardware components including, for example, at least one digital signal processor (DSP), a processor, a controller, an application-specific integrated circuit (ASIC), a programmable logic element, such as a field programmable gate array (FPGA), other electronic devices, or combinations thereof. At least some of the functions or the processes described in the embodiments may be implemented by software, and the software may be recorded on a recording medium. The components, the functions, and the processes described in the embodiments may be implemented by a combination of hardware and software.

The embodiments described herein may be implemented using a hardware component, a software component and/or a combination thereof. A processing device may be implemented using one or more general-purpose or special-purpose computers, such as, for example, a processor, a controller, an arithmetic logic unit (ALU), a digital signal processor (DSP), a microcomputer, an FPGA, a programmable logic unit (PLU), a microprocessor, or any other device capable of responding to and executing instructions in a defined manner. The processing device may run an operating system (OS) and one or more software applications that run on the OS. The processing device may also access, store, manipulate, process, and create data in response to execution of the software. For purpose of simplicity, the description of a processing device is used as singular; however, one of ordinary skill in the art will appreciate that a processing device may include multiple processing elements and/or multiple types of processing elements. For example, the processing device may include a plurality of processors, or a single processor and a single controller. In addition, different processing configurations are possible, such as parallel processors.

The software may include a computer program, a piece of code, an instruction, or one or more combinations thereof, to independently or collectively instruct or configure the processing device to operate as desired. Software and/or data may be stored in any type of machine, component, physical or virtual equipment, or computer storage medium or device capable of providing instructions or data to or being interpreted by the processing device. The software may also be distributed over network-coupled computer systems so that the software is stored and executed in a distributed fashion. The software and data may be stored in a non-transitory computer-readable recording medium.

The methods according to the embodiments may be recorded in non-transitory computer-readable media including program instructions to implement various operations of the embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as compact disc-read only memory (CD-ROM) and digital video discs (DVDs); magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter.

The above-described hardware devices may be configured to act as one or more software modules in order to perform the operations of the above-described embodiments, or vice versa.

Although the embodiments have been described with reference to the limited drawings, one of ordinary skill in the art may apply various technical modifications and variations based thereon. For example, suitable results may be achieved if the described techniques are performed in a different order, and/or if components in a described system, architecture, device, or circuit are combined in a different manner, or replaced or supplemented by other components or their equivalents.

Therefore, other implementations, other embodiments, and equivalents to the claims are also within the scope of the following claims.

What is claimed is:

1. An energy trading method performed by an energy market of an energy trading system, the energy trading method comprising:
receiving environmental, social and governance (ESG) demand information from a target energy consumer of which an energy demand quantity is greater than an energy generation quantity among energy consumers of the energy trading system;
receiving power generation information from an energy provider of the energy trading system;
identifying a power generation quantity of the energy provider required to meet a demand of the target energy consumer using the received ESG demand information and the received power generation information;
determining a power generation price that the target energy consumer needs to pay for purchasing energy from the energy provider according to the identified power generation quantity of the energy provider; and
calculating an energy distribution quantity for each of target energy consumers to enhance ESG of all the target energy consumers based on the determined power generation price.

2. The energy trading method of claim 1, wherein the ESG demand information comprises at least one of an energy purchase quantity, a greenhouse gas emission quantity, or a new and renewable energy generation rate of the target energy consumer.

3. The energy trading method of claim 1, wherein the power generation information comprises at least one of an energy quantity currently stored or an energy production cost required to produce additional energy of the energy provider.

4. The energy trading method of claim 1, wherein the calculating of the energy distribution quantity comprises determining an energy distribution quantity per unit time for each of the target energy consumers so that a total utility of all the target energy consumers is maximized.

5. The energy trading method of claim 4, wherein the total utility of all the target energy consumers is determined based on a greenhouse gas emission quantity and a new and renewable energy generation rate comprised in the ESG demand information.

6. An energy trading method performed by an energy market of an energy trading system, the energy trading method comprising:
receiving power generation information from an energy provider of the energy trading system;
receiving renewable energy certificate (REC) information corresponding to surplus energy from a target energy consumer of which an energy demand quantity is less than an energy generation quantity among energy consumers of the energy trading system;
identifying a power generation quantity that is reducible by the energy provider using the received REC information and the received power generation information;
determining an REC price for the target energy consumer to sell surplus energy according to the identified power generation quantity of the energy provider; and
transmitting the determined REC price to the energy provider,
wherein the energy provider purchases surplus energy from the target energy consumer at the determined REC price.

7. The energy trading method of claim 6, further comprising receiving greenhouse gas credit information from the target energy consumer,
wherein the energy provider adjusts a surplus energy quantity purchased from the target energy consumer based on the greenhouse gas credit information transmitted from the energy market.

8. An energy trading system comprising an energy provider, an energy market, and an energy consumer,
wherein the energy market receives environmental, social and governance (ESG) demand information from a target energy consumer of which an energy demand quantity is greater than an energy generation quantity among energy consumers of the energy trading system, receives power generation information from an energy provider of the energy trading system, identifies a power generation quantity of the energy provider required to meet a demand of the target energy consumer using the received ESG demand information and the received power generation information, determines a power generation price that the target energy consumer needs to pay for purchasing energy from the energy provider according to the identified power generation quantity of the energy provider, and calculates an energy distribution quantity for each of target energy consumers to enhance ESG of all the target energy consumers based on the determined power generation price.

9. The energy trading system of claim 8, wherein the ESG demand information comprises at least one of an energy purchase quantity, a greenhouse gas emission quantity, or a new and renewable energy generation rate of the target energy consumer.

10. The energy trading system of claim 8, wherein the power generation information comprises at least one of an energy quantity currently stored or an energy production cost required to produce additional energy of the energy provider.

11. The energy trading system of claim 8, wherein the energy market comprises determining an energy distribution quantity per unit time for each of the target energy consumers so that a total utility of all the target energy consumers is maximized.

12. The energy trading system of claim 11, wherein the total utility of all the target energy consumers is determined based on a greenhouse gas emission quantity and a new and renewable energy generation rate comprised in the ESG demand information.
